(19) United States
(12) Patent Application Publication
(10) Pub. No.: US 2012/0293544 A1
(43) Pub. Date: Nov. 22, 2012

(54) IMAGE DISPLAY APPARATUS AND METHOD OF SELECTING IMAGE REGION USING THE SAME

(75) Inventors: Arata Miyamoto, Tokyo (JP); Shingo Yanagawa, Kanagawa-ken (JP); Tomokazu Wakasugi, Kanagawa-ken (JP)

(73) Assignee: KABUSHIKI KAISHA TOSHIBA, Tokyo (JP)

(21) Appl. No.: 13/399,725

(22) Filed: Feb. 17, 2012

(30) Foreign Application Priority Data
May 18, 2011 (JP) P2011-111249

(51) Int. Cl. G09G 5/00

(52) U.S. Cl. 345/620; 345/156; 345/649

(57) ABSTRACT

According to an embodiment of the invention, in an image display apparatus, the image capturing unit captures an image including the hands of the operator. The gesture recognition unit recognizes at least one type of hand shapes of both hands in the captured image of the operator as a recognition object, compares a first geometric region defined by the hand shapes of both hands presented by the operator with the display screen, and recognizes the first geometric region as a second geometric region in a display screen coordinate system. The image generation unit performs emphasis processing of an image of the second geometric region displayed on the display screen. The display unit displays the emphasized image of the second geometric region on the display screen.

### CROSS REFERENCE TO RELATED APPLICATION

This application is based upon and claims the benefit of priority from the prior Japanese Patent Application No. 2011-111249, filed on May 18, 2011, the entire contents of which are incorporated herein by reference.

### FIELD

The embodiments described herein relate to an image display apparatus and a method of selecting an image region using the same.

### BACKGROUND

Various gesture recognition devices are known to recognize a gesture operating an image content and a GUI (graphical user interface) displayed on an image display apparatus. Some of the gesture recognition devices are configured to receive selection of a single object on an image display apparatus made by a pointing action, and other some devices are configured to receive selection of a plurality of objects made by a sequence of hand and finger actions, for example.

For selection of a single object made by a pointing action, an operator (a user) designates a point of coordinates of focus. Thus, the above selection mode is suitable for an operation to click an icon on a GUI, but has difficulty in recognizing a particular region of an image which is freely selected. On the other hand, for selection of a plurality of objects made by a sequence of hand and finger actions, a gesture recognition device needs to analyze a series of images of gestures presented by an operator. For this reason, the obtained meaning of the actions is reflected on the image display apparatus only after the operator completes the sequence of actions and thus a time lag occurs between the start and end of the operation by the operator. Moreover, even by use of the latter selection mode, the operator has, difficulty in giving two instructions, at the same time, to select a particular region of an image and to execute editing processing such as translation, scaling, and rotation of the selected particular region.

### BRIEF DESCRIPTION OF THE DRAWINGS

FIG. 1 is a block diagram showing a configuration of an image display apparatus according to a first embodiment of the invention;

FIG. 2 is a block diagram showing a configuration of a gesture recognition unit according to the first embodiment;

FIG. 3 is an operation flowchart for explaining a gesture recognition method according to the first embodiment;

FIG. 4 is a table showing examples of trigger operations according to the first embodiment;

FIG. 5 is an operation flowchart for explaining a method of selecting a rectangular image region according to the first embodiment;

FIG. 6 is a block diagram showing a configuration of an image display apparatus of a modification;

FIG. 7 is a block diagram showing a configuration of an image display apparatus according to a second embodiment;

FIG. 8 is an operation flowchart for explaining a method of editing processing of a rectangular image region according to the second embodiment;

FIG. 9 is a view showing boundary emphasis processing of a selected rectangular image region according to the second embodiment;

FIG. 10 is a block diagram showing a configuration of an image display apparatus according to a third embodiment; and

FIG. 11 is a block diagram for explaining a layout of a display screen according to a fourth embodiment.

### DETAILED DESCRIPTION

According to an embodiment of the invention, an image display apparatus includes an image capturing unit, a gesture recognition unit, an image generation unit, and a display unit. An instruction for image processing of a display screen is provided to the image display apparatus by means of hand shapes of both hands presented by an operator. The image capturing unit captures an image including the hands of the operator. The gesture recognition unit recognizes at least one type of hand shapes of both hands in the captured image of the operator as a recognition object, compares a first geometric region defined by the hand shapes of both hands presented by the operator with the display screen, and recognizes the first geometric region as a second geometric region in a display screen coordinate system. The image generation unit performs emphasis processing of an image of the second geometric region displayed on the display screen. The display unit displays the emphasized image of the second geometric region on the display screen.

According to another embodiment, a method of selecting an image region using an image display apparatus performs selection of an image region on a display screen of a display unit through first to fourth steps based on hand shapes of both hands presented by an operator with use of an image display apparatus including the display unit, an image capturing unit, a gesture recognition unit, and an image generation unit. In the first step, an image including the hands of the operator is captured. In the second step, a captured image defined by a first L-shaped gesture formed by the right hand of the operator and a second L-shaped gesture formed by the left hand of the operator, positioned diagonally to the first L-shaped gesture, is recognized as a first rectangular region. In the third step, the first rectangular region is compared with the display screen and the first rectangular region is recognized as a second rectangular region in a display screen coordinate system. Then, the second rectangular region is arranged parallel or perpendicular to one side of the display screen. In the fourth step, the image of the second rectangular region displayed on the display screen is highlighted.

More embodiments will be described below with reference to the drawings. Note that in the drawings, identical reference numerals designate identical or similar portions.

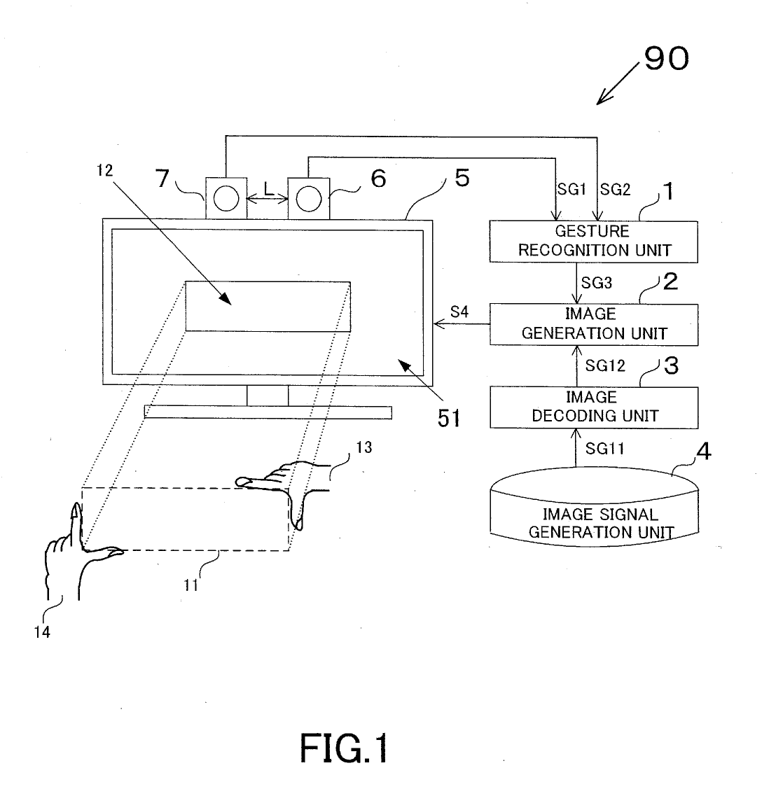

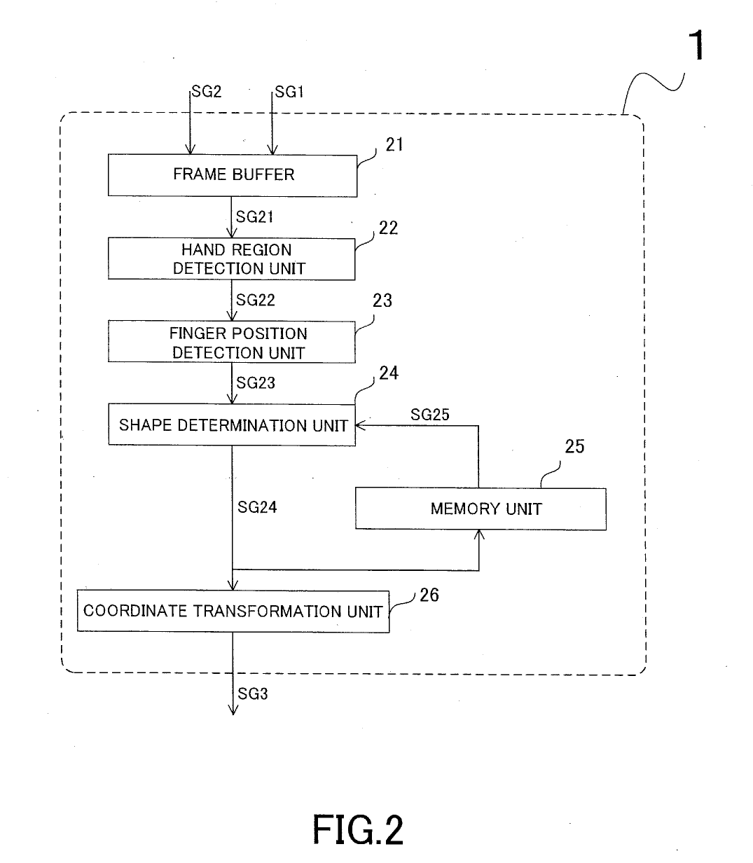

An image display apparatus and a method of selecting an image region using the same according to a first embodiment of the invention will be described with reference to the drawings. FIG. 1 is a block diagram showing a configuration of an image display apparatus. FIG. 2 is a block diagram showing a configuration of a gesture recognition unit. In the embodiment, an image display apparatus recognizes a first rectangular region defined by L-shaped gestures which are respectively formed by both hands of an operator (a user). Then, the image display apparatus compares the first rectangular region with a display screen and recognizes the first rectangular region as a second rectangular region in a display screen coordinate system, and an image of the second rectangular region displayed on the display screen is highlighted.

As shown in FIG. 1, an image display apparatus 90 is provided with a gesture recognition unit 1, an image generation unit 2, an image decoding unit 3, an image signal generation unit 4, a display unit 5, an image capturing unit 6, and another image capturing unit 7. Here, the image display apparatus 90 is applied to a digital TV set. However, the image display apparatus 90 is also applicable to digital home appliances such as a DVD recorder, amusement machines, digital signage, mobile terminals, in-vehicle devices, ultrasonic diagnostic equipment, electronic paper displays, personal computers, and so forth.

An instruction for image processing of a display screen 51 displayed on the display unit 5 is provided to the image display apparatus 90 by means of hand shapes of both hands or motions of both hands presented by an operator (a user). For example, as shown in FIG. 1, a rectangular region 11 (a first geometric region) is presented by a first L-shaped gesture formed by the thumb and the index finger of the right hand 13 of the operator and a second L-shaped gesture, which is positioned diagonally to the first L-shaped gesture, and is formed by the thumb and the index finger of the left hand 14 of the operator. A rectangular region 12 (a second geometric region) on the display screen 51 corresponding to the presented rectangular region 11 is recognized accordingly. An image of the recognized rectangular region 12 is displayed in an emphasized manner (to be described later in detail). Each of the rectangular region 11 and the rectangular region 12 is formed either into a rectangle or a square.

Although the L-shaped gestures are used here, the gestures are not necessarily limited to the foregoing. For example, it is also possible to use a mode of presenting the index fingers on both hands to define the respective finger tips as two corners of a rectangle. Note that the image may be a still image or a moving image.

The image signal generation unit 4 includes either of a memory unit or a broadcast signal receiver. When the image signal generation unit 4 includes the memory unit, stored image information is outputted in the form of a signal SG11, serving as an image signal, to the image decoding unit 3. When the image signal generation unit 4 includes the broadcast signal receiver, received image information is outputted in the form of the signal SG11 serving as the image signal to the image decoding unit 3.

The image decoding unit 3 is located between the image signal generation unit 4 and the image generation unit 2. The image decoding unit 3 receives the signal SG11 which is outputted from the image signal generation unit 4, and outputs a signal SG12 serving as a decoded image signal to the image generation unit 2.

The image capturing unit 6 is placed on an upper end of the display unit 5. The image capturing unit 7 is placed on the upper end of the display unit 5 and is spaced by a distance L from the image capturing unit 6. The image capturing unit 6 and the image capturing unit 7 recognize the operator (the user) in front of a displaying side of the display unit 5 and capture the images including the hands and fingers as well as motions of the hands and fingers. The distance L is set to a distance adequate for allowing estimation of three-dimensional positions and postures of the operator's hands by using a parallax between the captured images. Image information containing the hands and fingers of the operator as well as the motions of the hands and fingers can be recognized three-dimensionally by providing the image capturing unit 6 and the image capturing unit 7. While video cameras are used here as the image capturing unit 6 and the image capturing unit 7, it is also possible to use web cameras, VGA cameras, and the like instead.

The gesture recognition unit 1 is located between the image capturing units 6, 7 and the image generation unit 2. As shown in FIG. 2, the gesture recognition unit 1 is provided with a frame buffer 21, a hand region recognition unit 22, a finger position detection unit 23, a shape determination unit 24, a memory unit 25, and a coordinate transformation unit 26.

The frame buffer 21 is located between the image capturing units 6, 7 and the hand region detection unit 22. The frame buffer 21 receives a signal SG1 which is an image information signal outputted from the image capturing unit 6 and receives a signal SG2 which is an image information signal outputted from the image capturing unit 7. The frame buffer 21 extracts image information on the operator from the signal SG1 and the signal SG2.

The hand region detection unit 22 is located between the frame buffer 21 and the finger position detection unit 23. The hand region detection unit 22 receives a signal SG21, which is an image information signal of the operator, and extracts image information corresponding to both hands of the operator from the image information on the operator.

The finger position detection unit 23 is located between the hand region detection unit 22 and the shape determination unit 24. The finger position detection unit 23 receives a signal SG22, which is an image information signal of both hands, and extracts image information corresponding to right fingers and left fingers from the image information on both hands.

The shape determination unit 24 is located between the finger position detection unit 23 and the coordinate transformation unit 26. Information on one or more types of gestures formed by the hands and fingers, which is stored in the memory unit 25, is inputted to the shape determination unit 24. The shape determination unit 24 receives a signal SG23 which is an image information signal of the fingers on both hands, estimates a geometric region defined by the fingers on both hands by using image information on the fingers on both hands, compares the geometric region with a gesture shape stored in advance in the memory unit 25, and approves the geometric region when the geometric region matches the gesture shape. Meanwhile, the shape determination unit 24 compares information on a sequence of moving images of the fingers on both hands with a gesture operation which is stored in advance in the memory unit 25, and approves the sequence of operation when the operation matches the gesture operation.

In the meantime, unapproved geometric region information and gesture operations are stored in the memory unit 25 as appropriate. The stored information is further added individual information including hand shapes and hand movements, and then is used for an improvement of recognition accuracy, subsequently.

The coordinate transformation unit 26 is located between the shape determination unit 24 and the image generation unit 2. The coordinate transformation unit 26 receives a signal SG24, which represents the gesture shape or the gesture operation determined by the shape determination unit 24 and includes an information signal of a distance from the display screen 5 to the hands. When the signal SG24 represents the gesture shape, the coordinate transformation unit 26 compares the rectangular region 11 formed by the fingers on both hands with the display screen 51 and recognizes the rectangular region 11 as the rectangular region 12 in the display screen coordinate system. In the meantime, the coordinate transformation unit 26 activates the rectangular region 12 based on another gesture shape. The activation means enabling a subsequent gesture operation. When the signal SG24 represents the gesture operation, the coordinate transformation unit 26 recognizes a motion of the rectangular region 11 formed by the fingers on both hands as a motion on the display screen 51 in the display screen coordinate system. Such a motion of the rectangular region 11 includes, for example, transfer of the rectangular region 11 while fixing the shape formed by the fingers on both hands, a change in the interval between the shapes formed by the fingers on both hands, rotation of the rectangular region 11, and so forth.

The image generation unit 2 is located between the coordinate transformation unit 26 of the gesture recognition unit 1 as well as the image decoding unit 3, and the display unit 5. The image generation unit 2 receives the signal SG12 which is the decoded image signal outputted from the image decoding unit 3 and a signal SG3 which represents coordinate transformation information outputted from the coordinate transformation unit 26.

When the image generation unit 2 receives the signal SG12 but does not receive the signal SG3, the image generation unit 2 outputs a signal S4 serving as an image decoding information signal to the display unit 5. The display unit 5 displays an image on a frame basis based on the signal S4 serving as the image decoding information signal. When the decoded image is displayed on the display screen 51 and the signal SG3 is inputted, the image generation unit 2 displays the image of the rectangular region 12 on the display screen 51 in an emphasized manner based on the signal SG3. Alternatively, the image generation unit 2 displays an image of the rectangular region 12 edited based on the signal SG3. The rectangular region 12 is arranged with the long sides thereof placed horizontally or vertically on the display screen 51, for example.

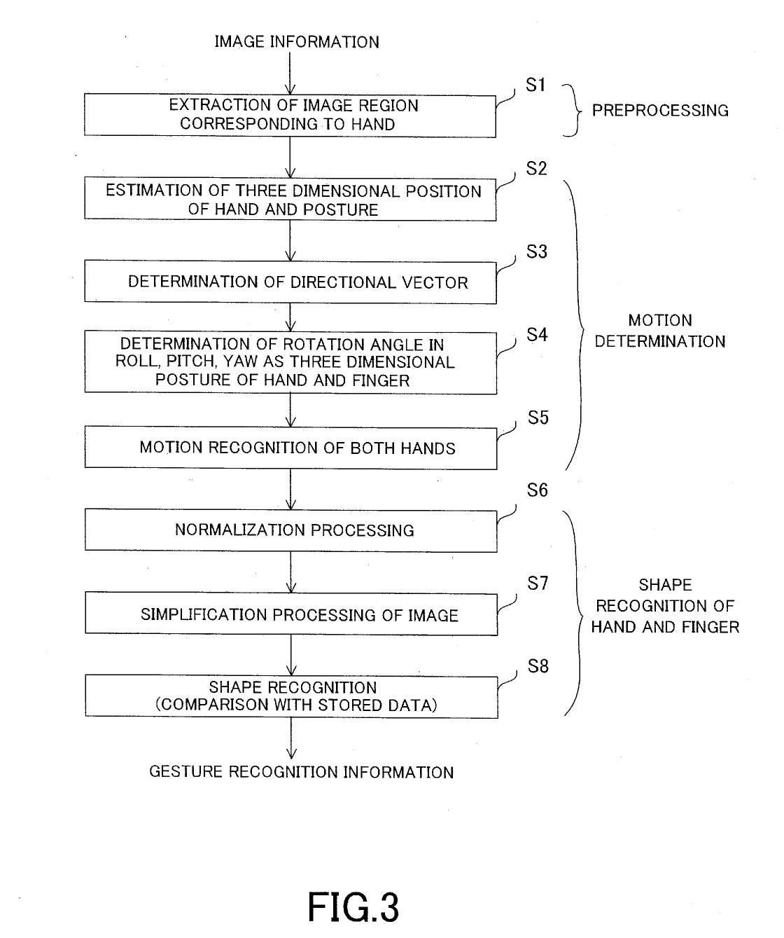

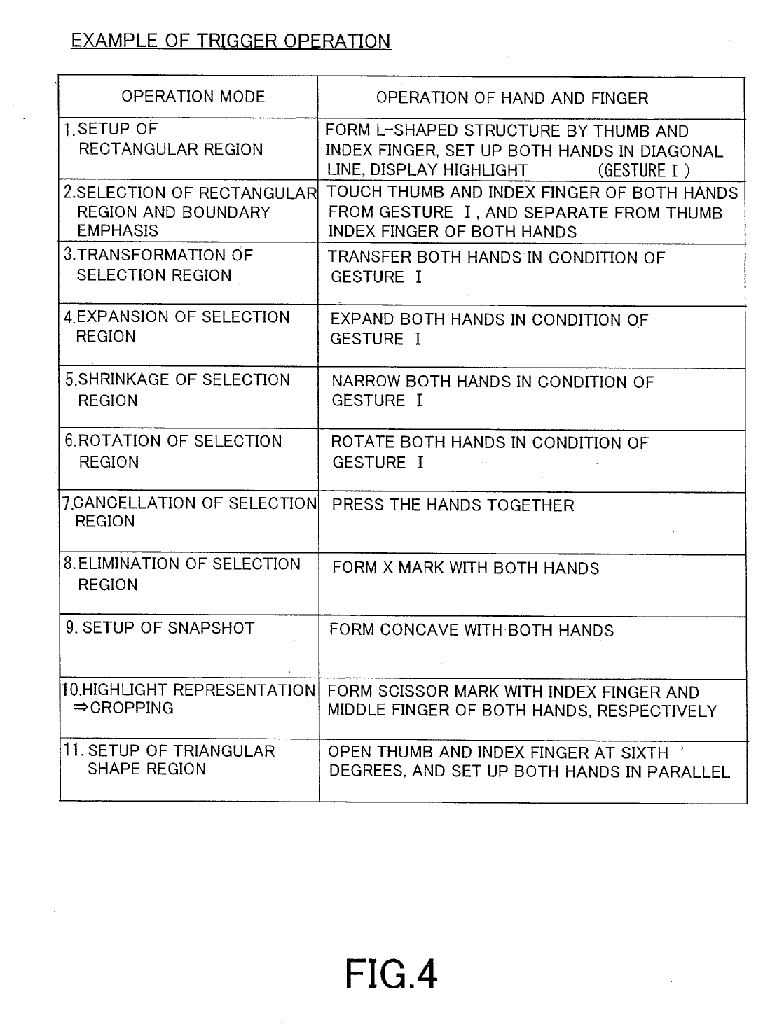

Next, a gesture recognition method will be described with reference to FIG. 3 and FIG. 4. FIG. 3 is an operation flowchart for explaining the gesture recognition method. In FIG. 3, preprocessing is executed in step S1, motion determination is executed in steps S2 to S5, and shape recognition of hands and fingers is executed in steps S6 to S8.

As shown in FIG. 3, the gesture recognition unit 1 performs processing on an image region corresponding to the hands included in the image information on the operator (the user) which is inputted to the frame buffer 21 (step S1). The processing involves region extraction based on background subtraction or colors, for example.

Next, the gesture recognition unit 1 estimates three-dimensional positions and postures of the hands based on geometric features of hand regions (step S2). Here, camera parameters are calculated in advance by using a camera calibration technique.

Then, directional vectors from the projection center to the three-dimensional positions of the hands are determined (step S3).

Next, yaw, pitch, and roll rotation angles are calculated based on the three-dimensional postures of the hands and fingers (step S4). Use of the pitch and yaw rotation angles in addition to the roll rotation angles makes it possible to correspond to various gesture operations shown in FIG. 4, for example.

After calculation of positions and rotation angles, the motion recognition of both hands is performed based on the calculation result (step S5). There is a method to match input patterns of hand trajectories and finger trajectories to time-series patterns which are learned in advance using CDP (Continuous dynamic Programming) method or HMM (Hidden Markov Model) method, for example.

Subsequently, normalization processing as preprocessing of shape recognition of hands and fingers is executed (step S6). Specifically, the region of the hands and fingers is translated and rotated to be located in the center of the image, and then is scaled in size so as to have an aspect ratio of 1.

Next, simplification processing of the image is executed by smoothing, thinning, and the like (step S7). It is possible to reduce the amount of information of the image and thereby to save a capacity of a CPU (central processing unit) or a processor by executing the normalization processing and the simplification processing of the image. Hence speeding up and cost reduction of the gesture recognition can be achieved.

Shape recognition of the hands and fingers is executed (step S8). For example, in the recognition of the rectangular region, HOG (Histogram of Oriented Gradients) feature values or Haar-like feature values are calculated using the image of hand regions and finger regions, and then is recognized whether or not an L-shaped gesture using a SVM (Support Vector Machine) which is composed of using stored data. The shapes and the motions of both hands thus recognized are compared with stored data to check whether the shapes and the motions match the data. The shapes and the motions matching the data will be used as gesture recognition information.

FIG. 4 is a table showing examples of trigger operations. As shown in FIG. 4, information on the trigger operations used for the gesture recognition is stored in the memory unit 25 of the gesture recognition unit 1. Here, operation modes 1 to 11 will be described as typical examples.

The operation mode 1 is for setup of the rectangular region. As for actions of the hands and fingers, the L-shaped gestures are respectively formed by using the thumbs and the index fingers on both hands and then both hands are diagonally located. For example, the thumb on the right hand is placed vertically while the index finger on the right hand is placed horizontally. In the meantime, the thumb on the left hand is placed horizontally while the index finger on the left hand is placed vertically. In the mode, the rectangular region 12 on the display screen 51 is highlighted at any time (the operation will be hereinafter referred to as a gesture I).

The operation mode 2 is for selection (activation) and boundary emphasis of the rectangular region. An operation is performed in such a way as to bring the thumbs and the index fingers on both hands in the gesture I into contact and then to release the contact. Accordingly, an image in the rectangular region is activated and can be edited. A boundary of the selected rectangular region is emphasized by adding a thick line frame to an outer peripheral region of the rectangular region, for example.

The operation mode 3 is for transfer of the selection region. The image of the selected (activated) rectangular region can be transferred (horizontally or vertically, for example) on the display screen 51 by moving both hands while maintaining the condition of the gesture I.

The operation mode 4 is for enlargement of the selection region. An enlarged image of the selected (activated) rectangular region can be displayed on the display screen 51 by increasing a distance between both hands while maintaining the condition of the gesture I.

The operation mode 5 is for shrinkage of the selection region. A shrunk image of the selected (activated) rectangular region can be displayed on the display screen 51 by decreasing the distance between both hands while maintaining the condition of the gesture I.

The operation 6 is for rotation of the selection region. The image of the selected (activated) rectangular region can be rotated on the display screen 51 by rotating both hands while maintaining the condition of the gesture I.

The operation mode 7 is for cancellation of the selection. The selected geometric region can be cancelled when the operator presses both hands together.

The operation mode 8 is for elimination of the selection region. The image of the selected (activated) geometric region can be eliminated when the operator forms an x mark with both hands.

The operation 9 is for setup of a snapshot. The thumb on the right hand and the thumb on the left hand are placed horizontally and brought into contact. Then the index finger, the middle finger, the ring finger, and the little finger on the right hand are placed at an angle of 90° with respect to the thumb. Likewise, the index finger, the middle finger, the ring finger, and the little finger on the left hand are placed at an angle of 90° with respect to the thumb.

The operation mode 10 is for cropping of highlight representation. A highlighted image of the geometric region can be cropped when the operator forms scissors marks by using the index fingers and the middle fingers on both hands.

The operation mode 11 is for setup of a triangular geometric region. The thumb on the right hand is placed horizontally. Then, the index finger, the middle finger, the ring finger, and the little finger on the right hand are placed at an angle of 60° with respect to the thumb. The thumb on the left hand is placed horizontally and in alignment with the thumb on the right hand. Then, the index finger, the middle finger, the ring finger, and the little finger on the left hand are placed at an angle of 60° with respect to the thumb.

The above-described actions of the hands and fingers in the respective operation modes are merely examples and are not intended to limit the invention. For example, in order to set up the rectangular region, it is also possible to form the L-shaped gesture by using the thumb and the rest of four fingers instead of performing the L-shaped gesture just by using the thumb and the index finger.

When the various operation modes defined by using both hands as described above are stored in advance in the memory unit 25, a certain viewer among two or more viewers, who are watching image contents such as digital TV programs at the same time, can accurately point out as to which part in an image of a specific object of interest by the certain viewer is displayed when the certain viewer wishes to explain the specific object to other viewers. Moreover, an effect to achieve smooth communication among the viewers is also expected.

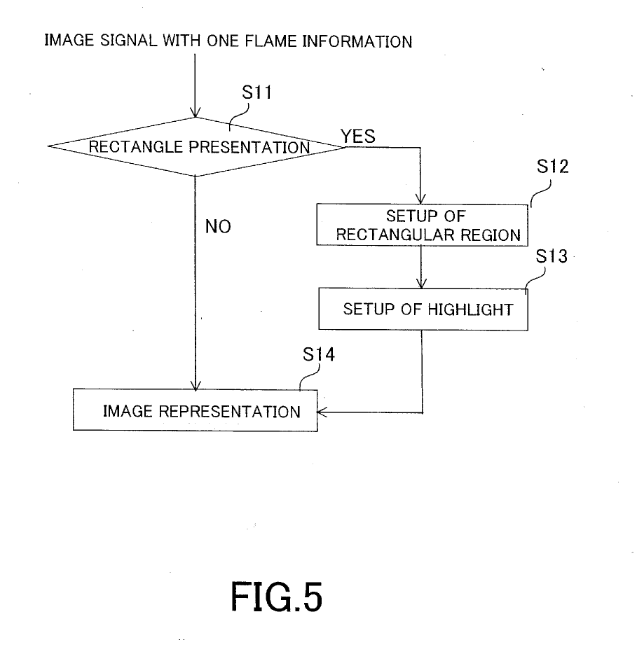

Next, a method of selecting a rectangular image region will be described with reference to FIG. 5. FIG. 5 is an operation flowchart for explaining the method of selecting a rectangular image region.

As shown in FIG. 5, the signal SG12 serving as the decoded image signal outputted from the image decoding unit 3 is inputted to the image generation unit 2 and an image for one frame is displayed on the display screen 51. Then, whether rectangle presentation is made or not is checked (step S11).

When the signal SG3 serving as a rectangle presentation signal is presented by the gesture recognition unit 1, the rectangular region 12 corresponding to the rectangular region 11 formed by the operation of the operator is displayed on the display screen 51 (step S12). The image for one frame is retained when the signal SG3 is not presented.

Next, the image of the rectangular region 12 is selected (step S13) and highlighted on the display screen 51. As for the highlight representation, for example, the rectangular region 12 may be displayed brighter than the surrounding region, or in the case of a color image, the color tone of the rectangular region 12 may be changed from the color tone of the surrounding region in order to emphasize the contrast (step S14).

As described above, according to the image display apparatus of the embodiment and the method of selecting an image region using the same, the apparatus is provided with the gesture recognition unit 1, the image generation unit 2, the image decoding unit 3, the image signal generation unit 4, the display unit 5, the image capturing unit 6, and the image capturing unit 7. An instruction for image processing of the display screen 51 displayed on the display unit 5 is provided by means of hand shapes of both hands or motions of both hands presented by an operator.

Accordingly, the operator can select and display a rectangular region on the display screen 51 arbitrarily in real time without using an input device such as a remote controller, a keyboard, a mouse or an icon on the screen.

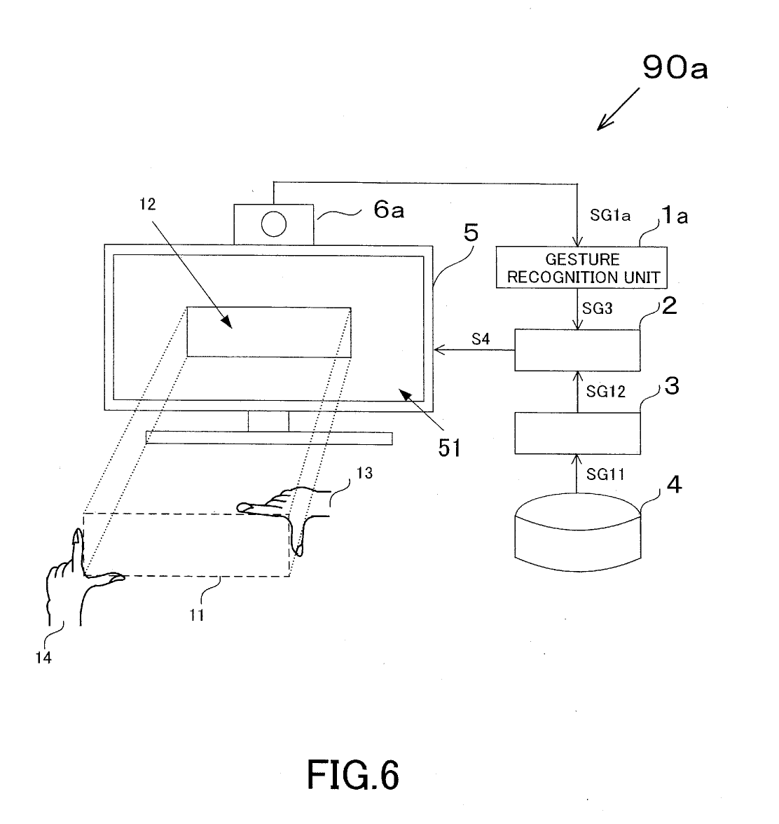

Although two cameras are provided as the image capturing units 6 and 7 in the embodiment, the invention is not limited only to the above-mentioned configuration. It is also possible to provide three or more cameras. Meanwhile, as shown in an image display apparatus 90a which is a modification illustrated in FIG. 6, a TOF (time of flight) camera may be used as an image capturing unit 6a. The TOF camera includes a distance sensor, an RGB camera, and the like and is capable of three-dimensionally recognizing the shapes of both hands or the motions of both hands presented by the operator. Therefore, the single TOF camera is sufficient for the image capturing unit.

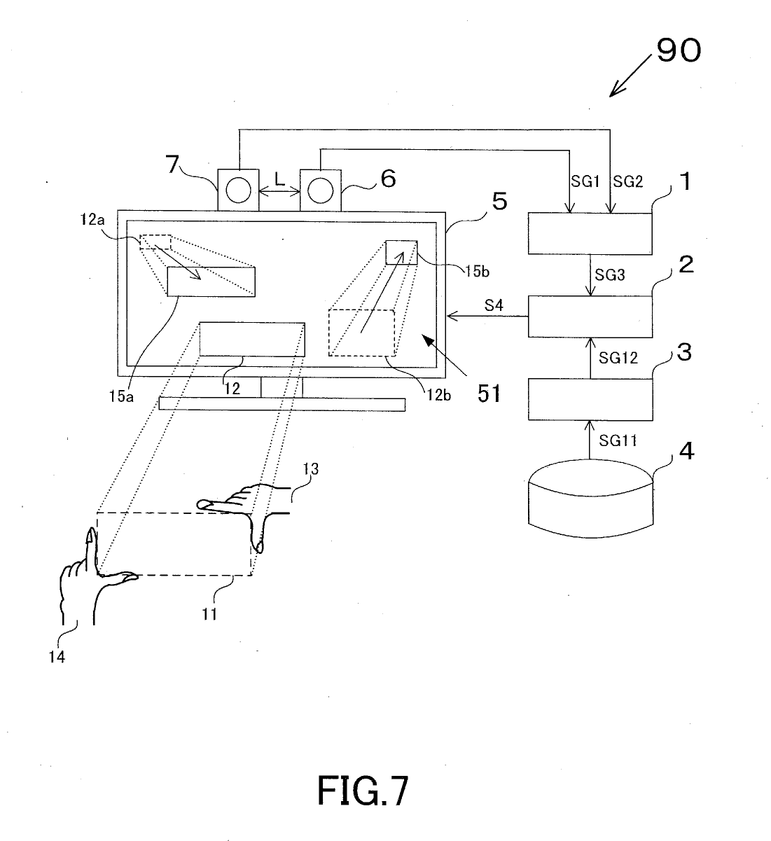

An image display apparatus and a method of selecting an image region using the same according to a second embodiment will be described with reference to the drawings. FIG. 7 is a block diagram showing a configuration of the image display apparatus. In the embodiment, an image in a selected rectangular region is edited in accordance with to a gesture operation formed by both hands of an operator.

In the following description, the same constituent portions as those in the first embodiment will be designated by the same reference numerals, and different features from the first embodiment will only be described below while the explanation of the same portions is omitted.

As shown in FIG. 7, the image display apparatus 90 of the second embodiment has the same configuration as the image display apparatus 90 of the first embodiment. The image display apparatus 90 of the second embodiment executes editing of partial images, editing of images, and so forth.

In the image display apparatus 90, a rectangular region 12a is selected by actions of both hands presented by the operator. An image of the selected rectangular region 12a is enlarged and transferred, and is displayed as an edit region 15a on the display screen 51. Instead, a rectangular region 12b formed on the display screen 51 is selected by actions of both hands presented by the operator. An image of the selected rectangular region 12b is shrunk in size and translated, and is displayed as an edit region 15b on the display screen 51.

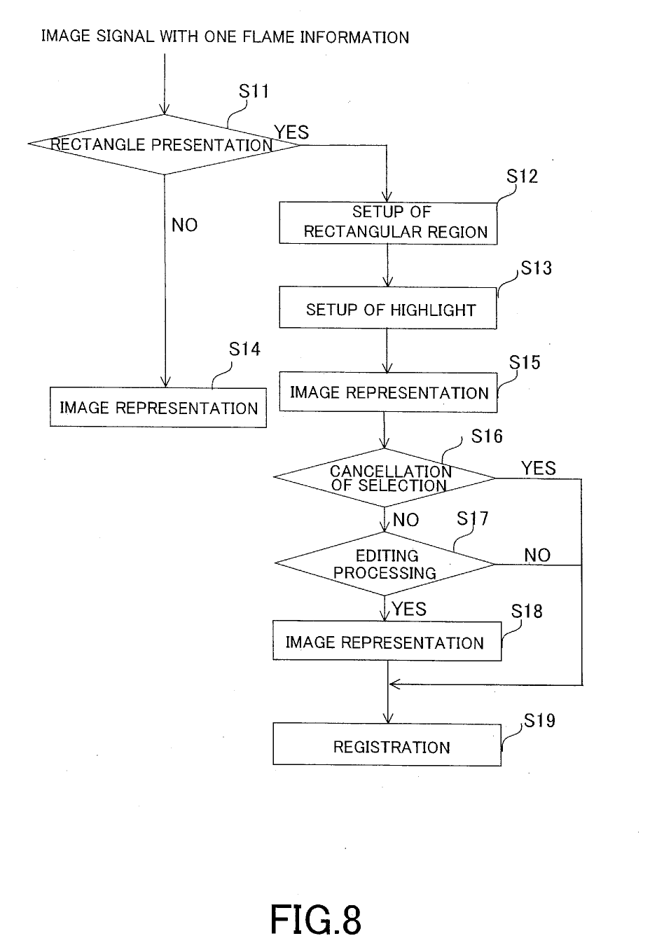

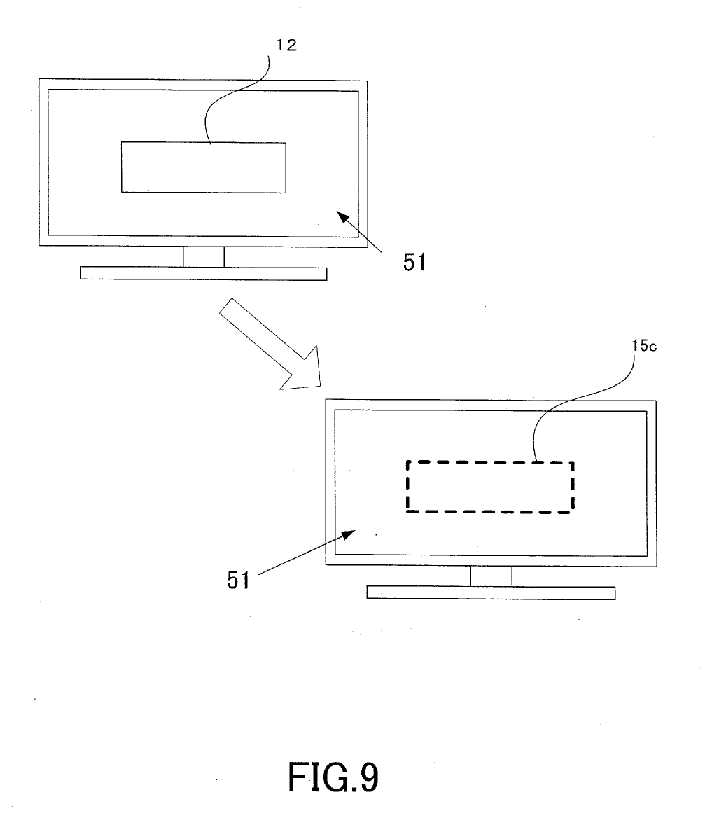

Next, the editing processing of the rectangular regions will be described with reference to FIGS. 8 and 9. FIG. 8 is an operation flowchart for explaining a method of editing processing of a rectangular region. FIG. 9 is a view showing boundary emphasis processing of the rectangular image region.

As shown in FIG. 8, the procedures from step S11 to step S15 of the editing processing of the rectangular region are the same as those of the first embodiment and the explanation on the procedures will therefore be omitted.

It is checked whether cancellation of selection of the image of the rectangular region selected and displayed as the image is made or not (step S16).

Next, when the cancellation of the selection is not made, whether or not to execute the editing processing of the selected rectangular region is checked (step S17).

Subsequently, when the execution of the editing processing is confirmed, the image of the rectangular region is edited according to motions of both hands presented by the operator (any selected one of the operation modes 3 to 6 shown in FIG. 4, for example), and the edited image thereof is displayed on the display screen 51 (step S18).

Then, the edited image of the rectangular region and the image of the rectangular region whose selection is cancelled are registered with an unillustrated memory unit (step S19).

Here, as the highlight representation of the rectangular region, it is also possible to execute processing (boundary emphasis processing) to display an edit region 15c with a thick line frame added to an outer peripheral region of the rectangular region 12 as shown in FIG. 9.

Use of the editing processing function makes it possible to implement an operation to change a display format of a region in the image of interest by the operator (the user) in such a way as to display an enlarged view or a shrunk view of the region on a corner of the display screen, for example, without using an input device such as a remote controller, a keyboard, a mouse or an icon on the screen. This editing processing can be executed in conjunction with playback of the image. Accordingly, the operator (the user) can change the display mode of the image contents seamlessly without having to interrupt the playback. Moreover, this function can be used regardless of whether the image display apparatus is playing back images stored in the memory unit or the apparatus is playing back images acquired from broadcast waves.

Here, the image display apparatus 90 is a digital TV set configured to play back the image contents. However, the above-described editing processing is also applicable to other GUIs including a desktop screen, a browser, and the like. For example, it is possible to achieve an operation to transfer a group of icons in a lump by enlarging or reducing a presented rectangle so as to change the size of a window in a selected state or to transfer the presented rectangle in the state of selecting a plurality of icons located in the rectangular region.

As described above, according to the image display apparatus of the embodiment and the method of selecting an image region using the same, the rectangular region is selected by the hand shapes or the motions of both hands presented by the operator, and the image of the rectangular region thus selected is edited.

Accordingly, it is possible to execute the processing to translate, shrink or rotate the image of the rectangular region on the display screen 51 in real time without using an input device such as a remote controller, a keyboard, a mouse or an icon on the screen. In addition, the operation can significantly reduce a time lag between the start and end of the operation by the operator.

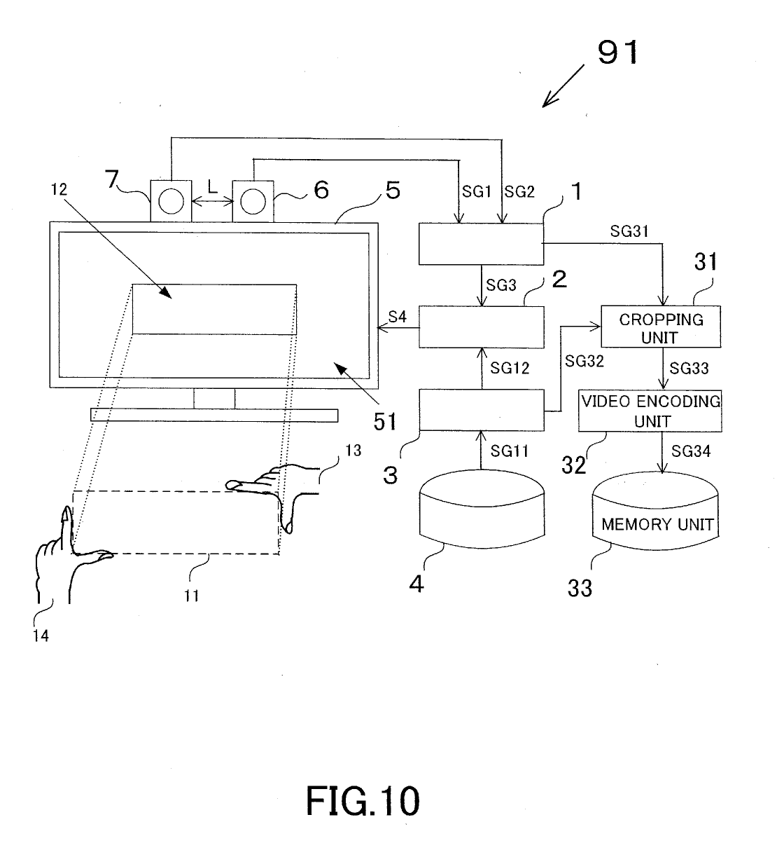

An image display apparatus according to a third embodiment will be described with reference to the accompanying drawing. FIG. 10 is a block diagram showing a configuration of the image display apparatus. In the embodiment, a rectangular region formed based on presentation of both hands of an operator is cropped, coded, and stored in a memory unit.

In the following description, the same constituent portions as those in the first embodiment will be designated by the same reference numerals, and different features from the first embodiment will only be described below while the explanation of the same portions is omitted.

As shown in FIG. 10, an image display apparatus 91 is provided with the gesture recognition unit 1, the image generation unit 2, the image decoding unit 3, the image signal generation unit 4, the display unit 5, the image capturing unit 6, the image capturing unit 7, a cropping unit 31, a video encoding unit 32, and a memory unit 33. Here, the image display apparatus 91 is applied to a digital TV set. However, the image display apparatus 91 is also applicable to digital home appliances such as a DVD recorder, amusement machines, digital signage, mobile terminals, in-vehicle devices, ultrasonic diagnostic equipment, electronic paper displays, personal computers, and so forth.

The cropping unit 31 is located between the gesture recognition unit 1 as well as the image decoding unit 3, and the video encoding unit 32. The cropping unit 31 receives a signal SG31 outputted from the gesture recognition unit 1 and a signal SG32 outputted from the image decoding unit 3. The cropping unit 31 crops image information on the geometric region such as the rectangular region on the display screen 51 recognized by the gesture recognition unit 1. The cropping unit 31 crops image information decoded by the image decoding unit 3 on a frame basis, for example. The cropping unit 31 controls a trigger operation to toggle between start and stop of the cropping.

The video encoding unit 32 is located between the cropping unit 31 and the memory unit 33. The video encoding unit 32 receives a signal SG33 outputted from the cropping unit 31. The video encoding unit 32 codes the image information cropped by the cropping unit 31.

The memory unit 33 receives a signal SG34 outputted from the video encoding unit 32. The memory unit 33 stores the image information coded by the video encoding unit 32.

In the image display apparatus 91, when the operator presents the operation mode 1 (setup of the rectangular region) and the operation mode 2 (selection of the rectangular region) shown in FIG. 4 by using both hands while targeting an object (a person or the like) of interest on the display screen 51, the selected rectangular region is highlighted on the display screen 51. When the operator presents the operation mode 10 (highlight representation→cropping) by using both hands in the aforementioned state, the image display apparatus 91 transitions to a cropping state.

In the cropping state, the rectangular region on the display screen 51 is highlighted and the image of the selected rectangular region is cropped by the cropping unit 31 at the same time. The cropped image is coded by the video encoding unit 32 and is then stored in the memory unit 33. When the operator presents the operation mode 3 (transfer of the selection region) shown in FIG. 4 by using both hands, the region cropped by the cropping unit 31 is also transferred dynamically in accordance with the operation mode 3. Likewise, the cropped region is either enlarged or shrunk when the operator presents the operation mode 4 (enlargement of the selection region) or the operation mode 5 (shrinkage of the selection region).

For a case where the operator does not wish to transfer the cropped region upon presentation of the operation mode 3, it is possible to additionally prepare a mode to dynamically transfer the cropped region and a mode to fix the cropped region, and to newly add a mode to switch between the above two modes.

The provision of the cropping unit 31 enables the image editing processing to crop only the object in the image of interest by the operator (the user). The cropped region can also be transferred by the operator presenting and transferring the rectangle. Accordingly, it is possible to crop the object of interest by the operator even when the object is moving on the display screen. Since the editing processing does not require an operation to stop or rewind the images, it is possible not only to perform off-line processing of the images stored in the image signal generation unit 4 but also to perform online processing of the images acquired from the broadcast waves.

As described above, the image display apparatus of the embodiment is provided with the gesture recognition unit 1, the image generation unit 2, the image decoding unit 3, the image signal generation unit 4, the display unit 5, the image capturing unit 6, the image capturing unit 7, the cropping unit 31, the video encoding unit 32, and the memory unit 33. The cropping unit 31 crops the image information on the rectangular region on the display screen 51 recognized by the gesture recognition unit 1. The video encoding unit 32 codes the image information on the rectangular region thus cropped. The memory unit 33 stores the coded image information on the rectangular region.

Accordingly, it is possible to execute the image editing processing easily while cropping only the rectangular region of interest by the operator.

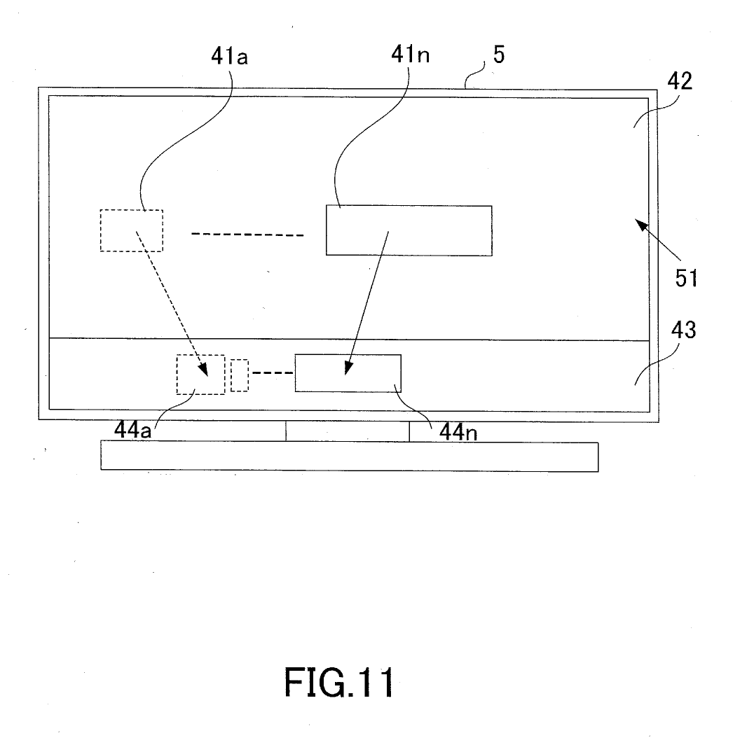

An image display apparatus according to a fourth embodiment will be described with reference to the accompanying drawing. FIG. 11 is a block diagram for explaining a layout of a display screen. In the embodiment, a snapshot display region is provided on a display screen in accordance with a certain shape presented by both hands of an operator.

In the embodiment, the image display apparatus has a similar configuration to that of the image display apparatus 90 of the first embodiment. As shown in FIG. 11, the display screen 51 is divided into an image display region 42 to display the image information generated by the image generation unit 2 and a snapshot display region 43 to display snapshots based on presentations of both hands of the operator (the user). The image display region 42 is displayed at an upper part of the display screen 51. The snapshot region 43 is displayed at a lower part of the display screen.

Here, when the operator presents the operation mode 1 (setup of the rectangular region) and the operation mode 2 (selection of the rectangular region) shown in FIG. 4 by using both hands, the selected rectangular region is highlighted on the display screen 51. When the operator presents the operation mode 9 (setup of the snapshot) shown in FIG. 4 by using both hands in the aforementioned state, an image in the rectangular region displayed at that moment on the display screen corresponding to the selected rectangular region is cropped as a snapshot of a still image and is displayed at a central portion in the snapshot display region 43. When the operator performs the trigger operation (the operation mode 9) n times, for example, the snapshot of the rectangular region is generated for each operation and the snapshots thus generated are added to the snapshot display region 43.

In the setup operation of the first snapshot, for example, an image of a rectangular region 41a in the image display region 42 is displayed as a snapshot 44a at the central portion in the snapshot display region 43. Similarly, in the setup operation of the n-th snapshot, an image of a rectangular region 41n in the center of the image display region 42 is displayed as a snapshot 44n in the center of the snapshot display region 43. In other words, the most recent snapshot will always be displayed at the central portion in the snapshot display region 43.

As described above, according to the image display apparatus of the embodiment, the rectangular region is selected by means of the hand shapes of both hands presented by the operator and the image of the selected rectangular region is displayed as the snapshot in the snapshot display region 43 on the display screen 51.

Accordingly, a plurality of snapshots can be displayed in chronological order in the snapshot display region 43 on the display screen 51 without using an input device such as a remote controller, a keyboard, a mouse or an icon on the screen.

The invention is not limited only to the above-described embodiments and various other modifications may be made without departing from the scope of the invention.

The geometric regions presented by both hands of the operator are the rectangular regions in the above-described embodiments. However, the geometric regions are not necessarily limited to the rectangular regions, but may have triangular shapes, circular shapes, or any rectangular shapes having the long sides not horizontal or vertical on the display screen 51, for example.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus configured to receive an instruction to perform image processing of a display screen made by hand shapes of both hands presented by an operator, the image display apparatus comprising:
an image capturing unit configured to capture an image including the hands of the operator;
a gesture recognition unit configured to recognize at least one type of hand shapes of both hands in the captured image of the operator as a recognition object, and configured to compare a first geometric region defined by the hand shapes of both hands presented by the operator with the display screen so as to recognize the first geometric region as a second geometric region in a display screen coordinate system;
an image generation unit configured to perform emphasis processing of an image of the second geometric region displayed on the display screen; and
a display unit configured to display the emphasized image of the second geometric region on the display screen.

2. The image display apparatus according to claim 1, wherein the first geometric region has a rectangular shape.

3. The image display apparatus according to claim 1, wherein the emphasis processing includes any of increasing the brightness of the image of the second geometric region and adding a thick line frame to an outer peripheral region of the second geometric region.

4. The image display apparatus according to claim 1, wherein the image capturing unit comprises:
a first camera configured to capture an image including the hands of the operator; and
a second camera placed at a distance from the first camera and configured to capture an image including the hands of the operator.

5. The image display apparatus according to claim 1, wherein the image capturing unit comprises a time-of-flight camera including a distance sensor and a red-green-blue camera.

6. The image display apparatus according to claim 1, further comprising:
an image signal generation unit configured to output image information; and
an image decoding unit configured to decode the image information and to output a decoded image signal obtained by decoding the image information to the image generation unit.

7. The image display apparatus according to claim 6, further comprising:
a cropping unit configured to crop the image of the second geometric region recognized by the gesture recognition unit and to control a trigger operation to toggle between start and stop of cropping;
a video encoding unit configured to encode the image of the second geometric region cropped; and
a memory unit configured to store information on the coded image of the second geometric region.

8. The image display apparatus according to claim 1, wherein
a snapshot display region is provided on the display screen and a snapshot is displayed in the snapshot region in response to a type of hand shapes of both hands presented by the operator.

9. The image display apparatus according to claim 1, wherein the image display apparatus is applied to any one of a digital television set, a digital home appliance, an amusement machine, digital signage, a mobile terminal, an in-vehicle device, ultrasonic diagnostic equipment, an electronic paper display, and a personal computer.

10. An image display apparatus configured to receive an instruction to perform image processing of a display screen made by hand shapes or motions of both hands presented by an operator, the image display apparatus comprising:
an image capturing unit configured to capture an image including the hands of the operator;
a gesture recognition unit configured to recognize at least one type of hand shapes or motions of both hands in the captured image of the operator as a recognition object, configured to compare a first geometric region defined by the hand shapes of both hands presented by the operator with the display screen so as to recognize the first geometric region as a second geometric region in a display screen coordinate system when the recognition object is the hand shapes of both hands, and configured to recognize the motions of both hands as an editing operation of the second geometric region when the recognition object is the motions of both hands;
an image generation unit configured to perform emphasis processing of an image of the second geometric region displayed on the display screen when the recognition object is the hand shapes of both hands, and configured to perform editing processing of the emphasized image of the second geometric region when the recognition object is the motions of both hands; and
a display unit configured to display the emphasized image of the second geometric region on the display screen and configured to display the edited image of the second geometric region on the display screen.

11. The image display apparatus according to claim 10, wherein the editing processing includes any of translation, scaling, and rotation of the image of the second geometric region.

12. The image display apparatus according to claim 10, wherein the first geometric region has a rectangular shape.

13. The image display apparatus according to claim 10, wherein the emphasis processing includes any of increasing the brightness of the image of the second geometric region and adding a thick line frame to an outer peripheral region of the second geometric region.

14. The image display apparatus according to claim 10, wherein the image capturing unit comprises:
a first camera configured to capture an image including the hands of the operator; and
a second camera placed at a distance from the first camera and configured to capture an image including the hands of the operator.

15. The image display apparatus according to claim 10, wherein the image capturing unit comprises a time-of-flight camera including a distance sensor and a red-green-blue camera.

16. A method of selecting an image region using an image display apparatus including a display unit, an image capturing unit, a gesture recognition unit, and an image generation unit and configured to receive a selection of an image region on a display screen of the display unit made by hand shapes of both hands presented by an operator, the method comprising the steps of:
capturing an image including the hands of the operator;
recognizing as a first rectangular region a captured image including a first L-shaped gesture formed by the right hand of the operator and a second L-shaped gesture formed by the left hand of the operator and positioned diagonally to the first L-shaped gesture;
comparing the first rectangular region with the display screen so as to recognize the first rectangular region as a second rectangular region in a display screen coordinate system, and arranging the second rectangular region so as to place the long sides of the second rectangular region horizontally or vertically on the display screen, and
performing emphasis processing of an image of the second rectangular region displayed on the display screen.

17. The method according to claim 16, the method further comprising the steps of:
selecting the second rectangular region which is performed emphasis processing of an image;
performing editing processing of the image of the selected second rectangular region; and
displaying the edited image of the second rectangular region on the display screen.

18. The method according to claim 17, wherein the editing processing is any of translation, scaling, and rotation of the image of the second rectangular region.
